(19) United States
(12) Patent Application Publication
(10) Pub. No.: US 2023/0096628 A1
(43) Pub. Date: Mar. 30, 2023

(54) FRICTION STIR WELDING TOOL AND METHOD FOR PRODUCING SAME

(71) Applicant: Stirtec GmbH, Premstätten (AT)

(72) Inventors: Gunter FIGNER, Graz (AT); Ozan CALISKANOGLU, Graz (AT); Lucus OPPENEIGER, Graz (AT); Christian PFEIFFER, Graz (AT)

(73) Assignee: Stirtec GmbH, Premstätten (AT)

(21) Appl. No.: 17/800,755

(22) PCT Filed: Feb. 1, 2021
(86) PCT No.: PCT/AT2021/060035

§ 371 Date: Aug. 18, 2022

(30) Foreign Application Priority Data
Feb. 20, 2020 (AT) A 50125/2020

(51) Int. Cl. B23K 20/12; B23K 20/227

(52) U.S. Cl. CPC B23K 20/1255; B23K 20/227; B23K 20/129; B23K 2103/04

(57) ABSTRACT

A friction stir welding tool, which includes a pin and a shoulder rigidly connected to the pin, for welding components composed of a parent material having a melting point of more than 900° C., in particular steel. To achieve a particularly long service life of the tool even with thick-walled components, it is provided that the shoulder is at least partially composed of a first material and the pin is at least partially composed of a second material. Furthermore, the shoulder is at least partially composed of a first: material and the pin is at least partially composed of a second material. In addition, a method for joining components of one or more parent materials having a melting temperature of more than 900° C. is provided.

The invention relates to a friction stir welding tool, which comprises a pin and a shoulder rigidly connected to the pin, for welding components composed of a parent material having a melting point of more than 900° C., in particular steel.

Furthermore, the invention relates to a method for producing a friction stir welding tool having a pin and a shoulder, with which method components of a parent material that has a melting temperature of more than 900° C. can be joined by means of friction stir welding.

In addition, the invention relates to a method for joining components of one or multiple parent materials having a melting temperature of more than 900° C., in particular for joining components of steel, preferably a structural steel, by friction stir welding.

Friction stir welding tools for joining components having a melting temperature of more than 900° C., in particular for joining components of a steel or multiple different steel alloys, are known from the prior art. Tools of this type comprise a pin and. a shoulder normally arranged perpendicularly to the pin. When two components arranged next to one another are joined, a compression force is applied via the shoulder to the components being joined. At the same time, a heating of the components takes place due to a rotation of the friction stir welding tool relative to the components about a rotation axis, so that the components are plasticized and mixed in a joining zone in the region of the friction stir welding tool, whereby the joining occurs. The pin thereby ensures a stirring of the plasticized material in the joining zone, and is thus exposed to large mechanical and thermal loads during the friction stir welding, whereas the shoulder of the friction stir welding tool is responsible for a large portion of the heat generation. A size of the shoulder thereby normally results from a maximum surface pressure under the shoulder and a necessary compression force in an. axial direction on the components being joined.

It has been shown that, when used in a friction stir welding tool, materials which have beneficial properties for use as pin material, for example a high melting temperature, result in an excessive or insufficient heat generation at the shoulder due to an excessive friction with the parent material of the components being joined, whereby an optimal weld is not achieved.

In order to prevent an excessive or insufficient temperature during the welding process, it is known from the prior art that the shoulder is embodied accordingly to be larger or smaller. Because of a non-optimal compression in the joining zone, however, this in turn causes problems with a quality of the welded joint.

It is furthermore known from the prior art that the shoulder and the pin are formed from separate component parts, and that the shoulder is driven at a different speed than the pin, in order to influence the heat input via the shoulder independently of a size of the shoulder using the rotational speed of the shoulder. However, it has been shown that, although the desired effect can be achieved in this manner when welding aluminum and other materials having a low melting temperature, plasticized material from the joining zone penetrates into a gap between the pin and the shoulder and causes damage to the tool, and thus a shorter service life of the same, when parent materials having a melting temperature of more than 900° C. such as steel, for example, are welded.

This is addressed by the invention, The object is to specify a friction stir welding tool of the type named at the outset, with which a particularly high quality of the welded joint with a simultaneously very long service life of the tool can be achieved, even with the given geometry of the friction stir welding tool.

In addition, a method for producing a friction stir welding tool of the type named at the outset shall be specified, with which a friction stir wielding tool of this type can be produced.

Finally, a method for joining components of the type named at the outset shall be specified, with which a particularly high quality of the connection can be achieved in an efficient manner.

According to the invention, the first object is attained with a friction stir welding tool of the type named at the outset, in which the shoulder is at least partially composed of a first material. and the pin is at least partially composed of a second material.

In the context of the invention, it was found that the disadvantages of friction stir welding tools from the prior art can be overcome if, in the region of the shoulder, the friction stir welding tool is at least partially composed of a different material than in a region of the pin. The first material typically differs from the second material, with which the first material. is rigidly connected, in terms of a chemical composition, in terms of mechanical properties and/or thermal properties. As a result, an optimized friction stir welding tool can he easily be formed depending on a desired application.

It is beneficial if the first material has a melting temperature of more than 900 ° C., preferably more than 2000° C.

It is preferably provided that the second material has a melting temperature of more than 900 ° C., preferably more than 2000° C., in particular more than 3000° C. A particularly long service life of the friction stir welding tool can thus be achieved. Typically, the melting temperature of the second material is higher than the melting temperature of the first material.

It has proven effective that the first material and the second material have different strengths. As a result, a tool that is particularly well-adapted to required conditions can be achieved, especially since a particularly high strength is typically necessary in the region of the pin in particular, whereas a lower strength is often sufficient in the region of the shoulder.

It is beneficial if a material pairing of the first material with the parent material has a first coefficient of kinetic friction and a material pairing of the second material with the parent material has a second coefficient of kinetic friction, wherein the first coefficient of kinetic friction differs from the second coefficient of kinetic friction, is in particular lower than the second coefficient of kinetic friction. In this manner, the tool can. be embodied such that it has, for example, a lower coefficient of kinetic friction m the region of the shoulder than in the region of the pin. It is thus ensured in a simple manner that, via the shoulder, a sufficiently high compression force can be introduced with a simultaneously low surface pressure, but with no excessive heat generation taking place and a friction also being sufficient in the region of the pin in order to stir the plasticized components in the joining zone for a particularly good connection.

Depending on desired conditions during the welding process, or on a necessary compression force at the shoulder, the materials can, of course, also be chosen such that the first coefficient of kinetic friction is greater than the second coefficient of kinetic friction.

Although it can be provided that the shoulder is entirely formed by the first material and the pin entirely by the second material, it is also possible to form the shoulder only partially using the first material and partially using the second material, and possibly one or more other materials. Analogously, the pin can also be formed only partially by the second material and the first material and possibly other materials. By correspondingly dividing the region of the shoulder and of the pin into partial regions that are composed of different materials having different coefficients of kinetic friction with the parent material, it is thus easily possible to achieve a desired coefficient of kinetic friction both in the region of the shoulder and in the region of the pin, wherein a mean coefficient of kinetic friction of the shoulder is typically different than a mean coefficient of kinetic friction of the pin.

This can be achieved, for example, in that the first component part is embodied to be ring-shaped, wherein an outer diameter of this first component part corresponds to the shoulder outer diameter, but an inner diameter of this first component part is embodied to be greater than a shoulder inner diameter, which shoulder inner diameter can coincide with a pin outer diameter. In the region of the shoulder, the first material then extends from the shoulder outer diameter to the inner diameter of the first component part over a first partial region of the shoulder, and the second material extends from the inner diameter of the first component part to the shoulder inner diameter, or to the pin, in the region of the shoulder. In addition, the pin can also be formed by the second material, so that the second component part can partially or entirely form a second partial region of the shoulder and the pin.

Normally, a mean coefficient of kinetic friction of the shoulder is lower than a mean coefficient of kinetic friction of the pin. A mean coefficient of kinetic friction can thereby be achieved via a corresponding area proportion. If the coefficient of kinetic friction is also dependent on a relative speed of the friction stir welding tool relative to the parent material, the speed of the respective area portions during the friction stir welding process can also be taken into consideration for the choice of that partial region of the shoulder which is composed of the first or the second material.

Even if a mathematical determination of the achievable mean coefficient of kinetic friction over the areas which are formed by the individual materials is preferred, a corresponding friction stir welding tool can, of course, also be formed in that a composition, necessary for the desired weld quality, of the region of the shoulder, that is, a size of that partial region of the shoulder which is composed of the first material and possibly of a second and/or third material, is determined in tests.

It is preferably provided that the first material has a different, in particular a lower, chemical affinity to the parent material than the second material. here, chemical affinity denotes the tendency of the respective material to bond with the parent material. Thus, in the region of the pin, it is advantageous if there is a high chemical affinity, in order to achieve a good stirring and therefore a high strength of the welded joint. In the region of the shoulder, a lower affinity than in the region of the pin can be advantageous, in order to achieve a weld with a smooth surface and to prevent an excessive heat input and excessive wear of the friction stir welding tool in the region of the shoulder. It is therefore beneficial if the first material has a lower chemical affinity to the parent material than the second material.

To form the friction stir welding tool, the first material can, in principle, be connected to the second material in any desired manner, for example by means of a force-fitting, a form-fitting, and/or a materially bonded connection method. For example, the friction stir welding tool can essentially be composed of the second material and be partially or completely coated with the first material in the region of the shoulder. It is also possible that, in the region of the shoulder, the first material is applied by means of deposition welding to a larger partial region of the friction stir welding tool, which partial region is composed of the second material.

Analogously, it is of course also possible that the pin composed of a second material or a partial region of the pin composed of the second material is connected to a larger first component part of the friction stir welding tool, which component part is composed of the first material, in particular in a force-fitting, a form-fitting, and/or materially bonded manner, for example by being welded-on or screwed-in.

Preferably, the friction stir welding tool comprises a ring composed of the first material, which ring is connected to a second component part composed of the second material by means of a welding method, in particular a friction stir welding method, which component part forms the pin and a partial region of the shoulder that is not formed by the ring. The ring composed of the first material can form an outer end of the shoulder or also be arranged in a groove, so that the ring forms a middle or inner first partial region of the shoulder.

Of course, a first component part of the friction stir welding tool formed from the first material or a second component part of the friction stir welding tool formed. from the second material can also at least partially or completely form a shaft of the friction stir welding tool.

Particularly for purposes of cost optimization, it can also be provided that the friction stir welding tool has a shaft which comprises a. third material, in particular is formed by a third material. In this manner, a use of cost-intensive materials that are used for the shoulder and the pin can be minimized, for example, whereby the friction stir welding tool can be produced with particularly low costs. The individual component parts, in particular the pin region, shoulder region, and shaft region, of the friction stir welding tool can be connected to one another in any possible form-fitting, force-fitting, and/or materially bonded manner, for example by friction welding.

Of course, depending on one or more different parent materials of which the component parts being welded are composed in the regions being welded, the friction stir welding tool can comprise widely different materials, and the first material can be formed by essentially any desired material. Particularly for achieving beneficial frictional properties at the shoulder, it has proven especially effective if the first material contains molybdenum, in particular is embodied as a molybdenum alloy.

The second material can, in principal, also be formed from any desired material suitable for a corresponding application. To achieve an especially long service life even with high temperatures occurring in the joining zone, it is preferably provided that the second material contains tungsten, in particular is formed by tungsten-rhenium.

To achieve correspondingly advantageous properties, it can also be provided that the first material and/or the second material comprises a ceramic material, in particular an oxide ceramic material, and/or a non-oxide ceramic material such as carbides, nitrides, or silicides, or is formed by a material of this type.

A particularly long service life can be achieved if the first material and/or the second material comprises a refractory metal, a refractory metal alloy, a nickel alloy, a cobalt alloy, and/or an iron alloy, or is formed by a material of this type. Refractory metals, that is, base metals of the 4th, the 5th, and the 6th group, titanium, zirconium, hafnium, vanadium, niobium, tantalum, chromium, molybdenum, and tungsten, have an extremely high melting temperature and beneficial mechanical properties for an application as a friction stir welding tool. The further object is attained with a method of the type named at the outset in which a first component part, which is composed of a first material, is rigidly connected to a second component part, which is composed of a second material, so that at least a partial region of the shoulder is formed by the first material and at least a partial region of the pin is formed by the second material.

In this manner, properties of the friction stir welding tool in the region of the shoulder can easily be achieved independently from properties in the region of the pin.

In order to form the friction stir welding tool, the first component part can, in principle, be connected to the second component part in any desired manner, for example, by a force-fitting and/or form-fitting connection. However, it is particularly preferred that the first component part is connected to the second component part in a materially bonded manner. A particularly robust connection is thus achieved.

Although the first component part can, in principle, be connected to the second component part, or the second component part to the first component part, in any desired materially bonded manner, for example by sintering, a 3D printing method, or the like, it is preferably provided that the first component part is welded to the second component part. In contrast to a sintering method, a coating method, or a 3D printing method, it is thus not absolutely necessary that an outer contour of the first component part be completely altered, or the first component part be completely fused, during the method. It can thus also be provided that the first component part and the second component part essentially retain an outer contour during the method for forming a friction stir welding tool. For example, the first component part can. thus be embodied as a ring which is welded onto the second component part, which comprises the pin and a portion of the shoulder, in particular having a groove for the first component part. The welding can, in turn, take place in widely different ways known from the prior art, for example by laser welding, diffusion welding, electron beam welding, or the like.

It has been shown that an especially robust connection between the first component part and the second component part can be achieved if the first component part is connected to the second component part using a friction welding method.

It is preferably provided that the first component part is connected to the second component part using a pressure welding method. In addition, a combination of a friction welding method with a pressure welding method is, of course, also possible.

It has proven effective that, depending on a desired mean coefficient of kinetic friction that acts during contact of the shoulder with the parent material and lies between a first coefficient of kinetic friction, which a material pairing of the first material with the parent material has, and a second coefficient of kinetic friction, which a material pairing of the second material with the parent material has, a first partial region of the shoulder is formed by the first material and a second partial region of the shoulder is formed by the second material, in order to achieve the desired mean coefficient of kinetic friction. In other words, the size of that partial region of the shoulder which is then formed by the first material if the shoulder is not entirely formed by the first material is chosen depending on which mean coefficient of kinetic friction is desired in the region of the shoulder. For example, if a mean coefficient of kinetic friction of the first material in a material pairing with the parent material, in particular in a material pairing with steel, in particular a high-strength structural steel as used for pipeline pipes, is 0.1 and a coefficient of kinetic friction of the second material in a material pairing with the same parent material is 0.3, a mean coefficient of kinetic friction of the shoulder of 0.2, for example, can thus be achieved in that an area of the shoulder in contact with the components being welded during the welding process is 50% formed from the first material and 50% funned from the second material. A surface of the shoulder is then composed of the first partial region and the second partial region, even though additional partial regions of other materials are, of course, also possible in principle. Because a speed of the shoulder in a region proximate to the pin or to the rotation axis is lower than at an outer edge and a coefficient of kinetic friction can also depend on a relative speed, different ratios of the regions of the shoulder that are formed from the first material and from the second material can result, depending on whether the first material is arranged on the inside or outside of the shoulder.

To achieve a particularly large effect when the first material, which preferably has a lower coefficient of kinetic friction than the second material, is used, the first material is typically arranged at an outer edge of the shoulder, for example as an outer ring. Thus, not only is an area proportion. of the shoulder that is formed by the first material or by the second material relevant for a quality of the weld or a heat input into the components being welded, but rather also, at least to a slight extent, a position in which the shoulder is formed by the first material or by the second material, or a distance of the corresponding position from a rotation axis of the friction stir welding tool.

Preferably, the friction stir welding tool is embodied to be roughly rotationally symmetrical.

To achieve particularly simple production, it is advantageously provided that, before a connection of the first component part to the second component part, the first component part is formed with a contour which corresponds to the partial. region of the shoulder that is formed from the first material. The first component part can thus, for example, be embodied as a ring that is positioned in a groove in the second component part, in order to form a corresponding portion of the shoulder. In principle, the first component part can, of course, also be embodied as a polygon or the like, in order to achieve a form-fitting connection to the second component part. The second component part can form both a portion of the pin, the entire pin, and also the partial or entire shaft of the tool.

It is preferably provided that the first component part has an essentially rotationally symmetrical outer contour, in particular is embodied to be roughly ring-shaped. This enables particularly simple production of the friction stir welding tool.

Of course, a friction stir welding tool embodied according to the invention can be formed by a method according to the invention.

The third object is attained according to the invention with a method of the type named at the outset in which a friction stir welding tool embodied according to the invention is used. As a result, a weld with particularly high quality is achieved with a simultaneously long service life of the friction stir welding tool.

Although in principal any desired components can be joined using a friction stir welding tool according to the invention, it has been shown that a corresponding friction stir welding tool is particularly well suited to being used in a corresponding method in which the components being joined are embodied to be tubular. Pipes with which a pipeline is built, for example, can thus be welded, without having to change the friction stir welding tool while forming a weld that runs along a circumferential direction. This is critical for accomplishing the construction of a pipeline that can be laid at a depth of 3000 m below the surfiice of the sea, for example, in a particularly efficient manner.

It is especially preferred if the method is used when the components have a wall thickness of more than 10 mm, particularly more than 20 mm, with a weld in particular extending over an entire wall thickness. The components, which are typically embodied to be flat, preferably tubular, are thus laid against one another before a welding along small faces of said components, so that the weld, when it extends from one surface of the components to an opposing surface of the components, has a height corresponding to the wall thickness, or corresponding to a height of the components' small faces lying against one another.

In order to still achieve a stable friction stir-welded joint even with correspondingly large wall thicknesses, the input of a particularly precisely defined amount of heat is necessary, especially since an. excessive or insufficient amount of heat would cause the friction stir-welded joint to not be optimal, at least over a partial region of the weld thickness. Such a precisely defined heat input is easily possible with a friction stir welding tool according to the invention, especially because a coefficient of kinetic friction of the shoulder is attainable independent of a coefficient of kinetic friction and material of the pin.

Additional features, advantages, and effects of the invention follow from the exemplary embodiments described below. In the drawings which are thereby referenced:

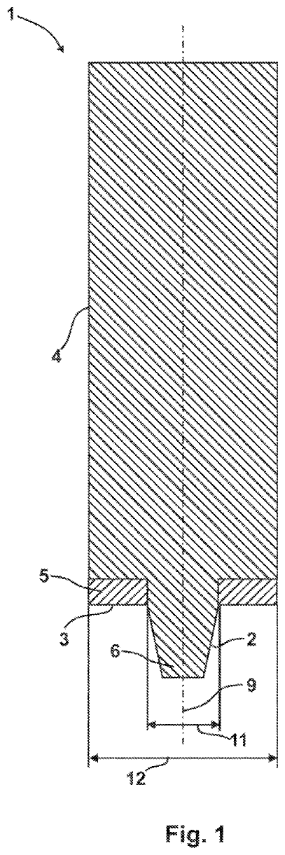

FIGS. 1 through 3 show different friction stir welding tools embodied according to the invention;

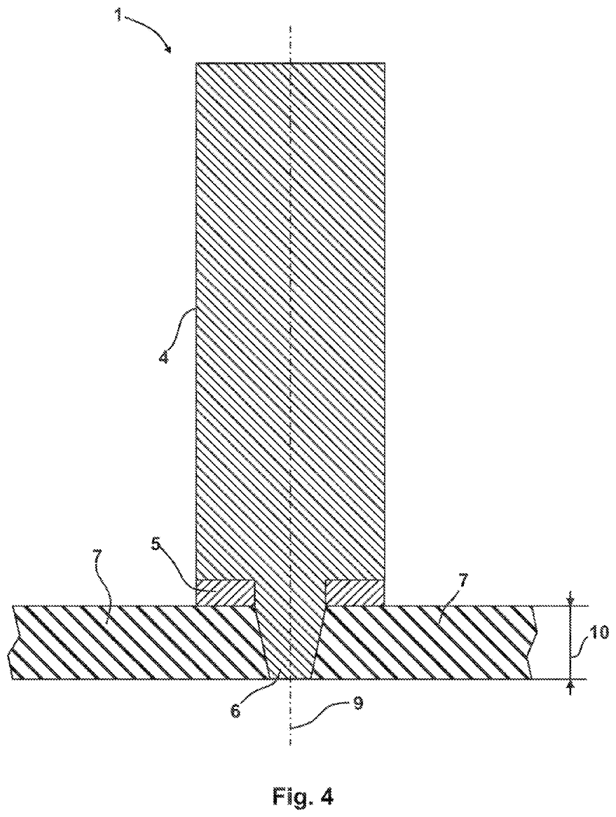

FIG. 4 shows a friction stir welding tool according to the invention during the welding of two components;

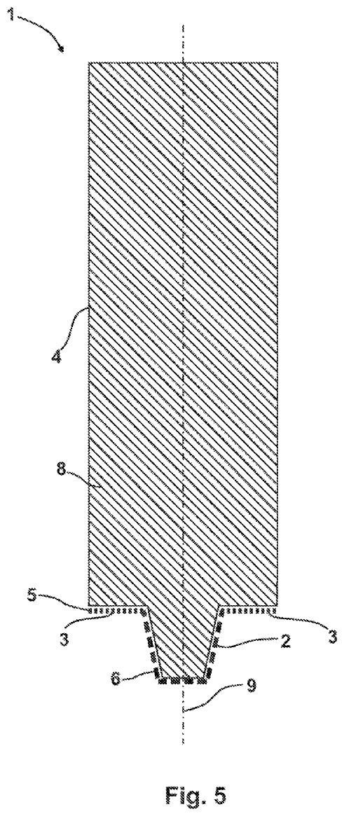

FIGS. 5 through 7 show further friction stir welding tools;

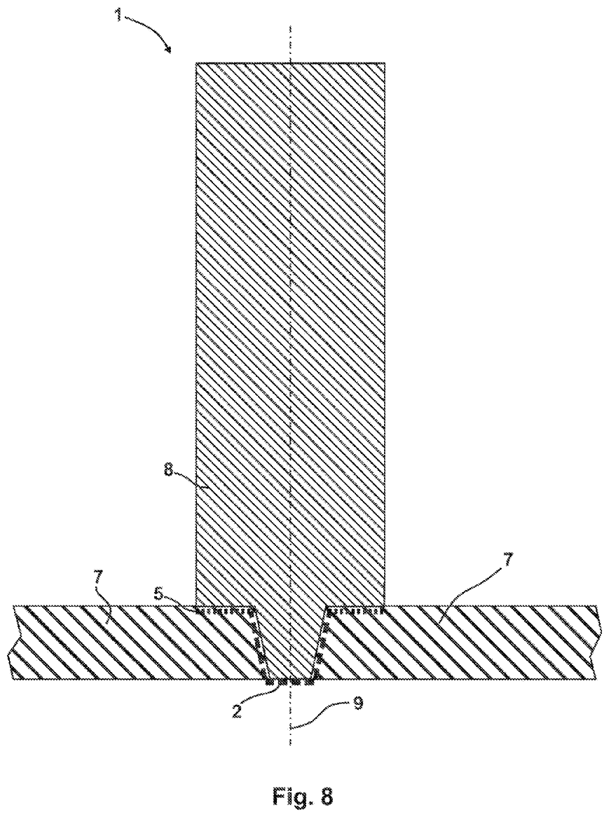

FIG. 8 shows a further friction stir welding tool during the joining of two components.

FIG. 1 shows a section through a friction stir welding tool 1 embodied according to the invention. As can be seen, the friction stir welding tool 1, which is embodied to be essentially rotationally symmetrical to a rotation axis 9, comprises a shaft 4, a pin 2, and a shoulder 3, wherein the shoulder 3 is oriented roughly perpendicularly to the rotation axis 9 and is formed by a first component part 5 of a first material, in this ease a molybdenum alloy, and the pin 2 and the shaft 4 are formed by a second component part 6 of a second material, in this case tungsten-rhenium. As illustrated, the first component part 5 is embodied to be ring-shaped, wherein an inner diameter 13 of the first component part 5 corresponds to a pin outer diameter 11, which in this case corresponds, in turn, to the shoulder inner diameter 13. An outer diameter of the ring-shaped first component part 5 corresponds to a shoulder outer diameter 12. The shoulder 3 is thus in this case entirely formed by the first component part 5 or the first material.

Due to the use of tungsten-rhenium in the region of the pin 2, a high temperature resistance is achieved with a tool of this type. Through the use of the molybdenum alloy in the region of the shoulder 3, a lower coefficient of kinetic friction is achieved at the shoulder 3 than in the region of the pin 2 when components 7 of a steel, in particular of structural steel, are being welded, so that a lower heat input via the shoulder 3 is achieved compared to a friction stir welding tool 1 composed solely of tungsten-rhenium, with identical process parameters such as contact pressure in an axial direction, rotational speed of the friction stir welding tool 1 about the rotation axis 9, and forward speed. In the region of the pin 2, a higher coefficient of kinetic friction, which the material pairing of tungsten-rhenium with structural steel exhibits, is beneficial for achieving an intensive stirring in a joining zone. Thus, using friction stir welding, components 7 with a large wall thickness 10 can also be welded together in such a manner that both a long service life of the friction stir welding tool 1 and a high quality of the welded joint are achieved.

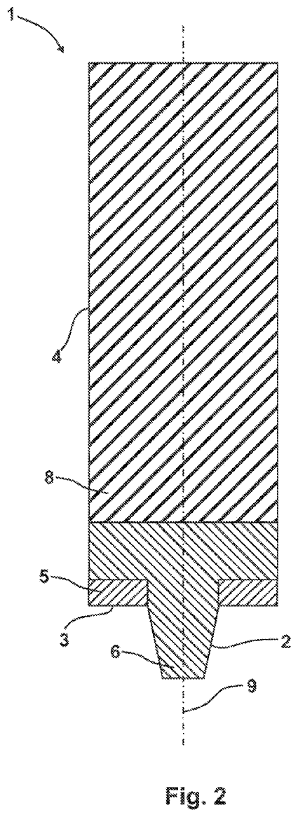

FIG. 2 shows a further friction stir welding tool 1 according to the invention. The shoulder 3 is once again entirely formed by a ring-shaped first component part 5 of a molybdenum alloy, whereas the pin 2 and a partial region of the shaft 4 are formed by a second component part 6 formed from tungsten-rhenium. In contrast to the friction stir welding tool 1 illustrated in FIG. 1, however, the shaft 4 here is formed only partially by the second component part 6 and is partially formed by a third component part 8 of a third material, which third material can be more favorable than tungsten-rhenium in terms of production costs, for example.

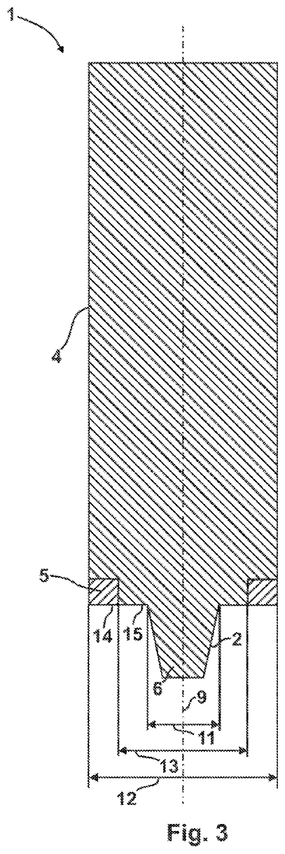

FIG. 3 shows a further exemplary embodiment of a friction stir welding tool 1 according to the invention. In this exemplary embodiment, the first component part 5 does not extend across the entire shoulder 3, but rather only forms a first partial region 14 of the shoulder 3, so that a second partial region 15 of the shoulder 3 is formed by the second component part 6, which the pin 2 is also formed by. Thus, only an outer first partial region 14 of the shoulder 3 is formed by the first component part 5, which in this case is also embodied to be ring-shaped and is composed of a molybdenum alloy. In this case, the ring-shaped first component part 5 therefore extends from the shoulder outer diameter 12 not to the pin 2, or not to the pin outer diameter 11, but rather only to an inner diameter 13 that lies roughly in the middle between a shoulder inner diameter 13 and the shoulder outer diameter 12. Here, the shoulder inner diameter 13 also corresponds to the pin outer diameter 11. By modifying the inner diameter 13 of the first component part 5, or by modifying the first partial region 14 formed by the first material and the second partial region 15 of the shoulder 3 formed by the second material, a desired mean coefficient of kinetic friction of the shoulder 3, which occurs in use on a parent material such as steel, for example, can thus be adjusted at will between a first coefficient of kinetic friction of a material pairing of the first material with the parent material and a second coefficient of kinetic friction of a material pairing of the second material with the parent material. In the exemplary embodiment, the first coefficient of kinetic friction of the material pairing of molybdenum alloy with steel is lower than the second coefficient of kinetic friction of the material pairing of tungsten-rhenium with steel, so that in the exemplary embodiment illustrated in FIG. 3, a mean coefficient of kinetic friction is obtained in th.e region of the shoulder 3 that is higher than the coefficient of kinetic friction of the material pairing of molybdenum alloy with steel and lower than the coefficient of kinetic friction of the material pairing of tungsten-rhenium with steel.

FIG. 4 shows a friction stir welding tool 1 according to FIG. 1 during the welding of second components 7, once again in a sectional illustration. As can be seen, the pin 2 extends essentially across an entire wall thickness 10 of the components 7, in this case embodied to be plate-shaped for example, which are composed of a steel, preferably a pipeline steel, and have a melting temperature of more than 90° C. Through the use of the first material in the region of the shoulder 3, a lower coefficient of kinetic friction is achieved in the region of the shoulder 3 than in the region of the pin 2, so that an advantageously intensive stirring of the parent materials of the components 7 is achieved in the region of the pin 2, whereas a comparatively low heat input occurs via the shoulder 3.

The ring-shaped first component part 5, from which the shoulder 3 in the exemplary embodiments illustrated in FIG. 1 through FIG. 4 is at least partially formed, is connected to the second component part 6 in the exemplary embodiments by means of a friction welding process, which second component part 6 forms the pin 2 and at least a partial region of the shaft 4.

This results in a rigid, stable connection, whereby it is also ensured that, between the first component part 5 and the second component part 6, there is no gap and therefore no plasticized material from the weld can penetrate into such a gap, as would be the case with a multi-part friction stir welding tool 1 in which, for example, the shoulder 3 rotates at a lower speed than the pin 2.

FIGS. 5 through 7 show further exemplary embodiments of a friction stir welding tool 1 according to the invention in sectional illustrations. In these exemplary embodiments, the shoulder 3 and the pin 2 of a friction stir welding tool 1 composed essentially of a third material are at least partially coated with different materials in order to obtain different frictional properties in the region of the pin 2 and in the region of the shoulder 3 when a friction stir welding method is carried out. The friction stir welding tool 1 can thereby essentially be composed of a third material and, as illustrated, be coated only in the region. of the shoulder 3 and in the region of the pin 2, in order to obtain the desired properties in these partial regions. In the exemplary embodiment illustrated in FIG. 5, a surface forming the shoulder 3 is thereby entirely coated with a first material and a surface forming the pin 2 entirely coated with a second material. Thus, in the exemplary embodiment illustrated in FIG. 5, the first component part 5 is embodied as a coating in the region of the shoulder 3 and the second component part 6 as a coating in the region of the pin 2, wherein the first component part 5 can, for example, also be composed of a molybdenum alloy and the second component part 6 once again of a tungsten alloy.

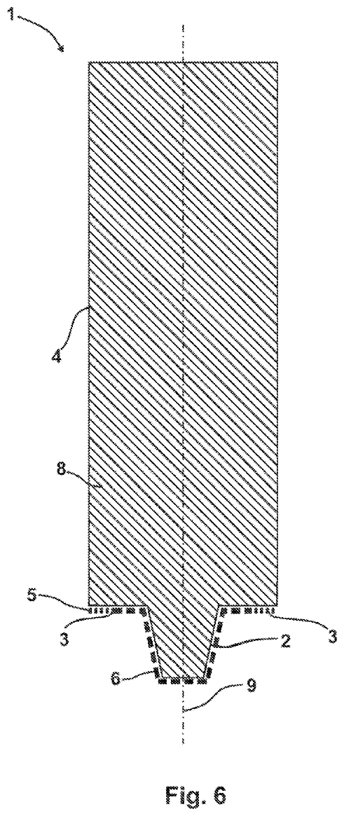

In the exemplary embodiment illustrated in FIG. 6, the first component part 5, which is likewise formed by a coating, only partially covers a surface in the region of the shoulder 3. Here, a coating not composed of the first material, or a partial region of the shoulder 3 not formed by the first component part 5, is formed by a coating formed from the second material, or by a second component part 6, which second component part 6 also forms a surface of the pin 2. In this manner, a coefficient of kinetic friction of the shoulder 3 that lies between the first coefficient of kinetic friction and the second coefficient of kinetic friction can once again be achieved.

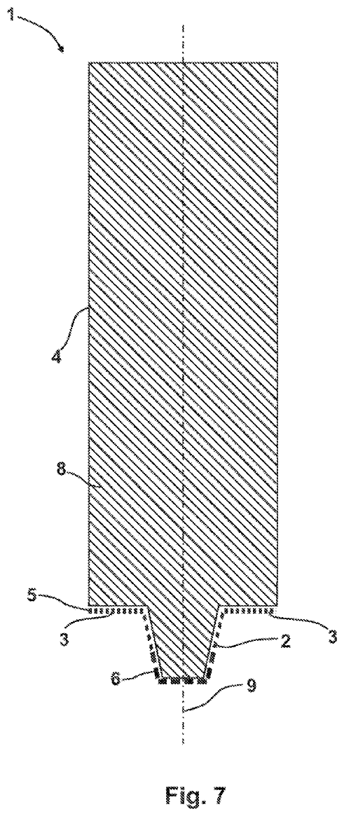

FIG. 7 shows a further embodiment in which a surface in the region of the shoulder 3 is formed by a first component part 5 composed of a first material, which first component part 5 is embodied as a coating. Here, a surface of the pin 2 is partially coated with the first material and partially with the second material, in order to obtain properties in this case which lie between the properties of the first material and the properties of the second material.

FIG. 8 shows the use of a friction stir welding tool 1 according to FIG. 5 during a method for joining corresponding components 7, once again in a sectional illustration.

As can be seen in FIGS. 5 through 8, the friction stir welding tool 1 can thus also be formed essentially by a third material or a third component part 8 which at the end side in the region of the shoulder 3 and of the pill 2 is coated with a first material that forms a first component part 5 and a second material that forms a second component part 6, in order to obtain corresponding properties. In contrast to the exemplary embodiments illustrated in Figs. I through 4, in the exemplary embodiments illustrated in FIGS. 5 through 8, the contours of the first component part 5 and of the second component part 6 are thus first formed during the production of the friction stir welding tool 1, namely by coating a surface of the third component part 8.

A corresponding friction stir welding tool 1 can, in principle, be used for widely different purposes. Preferably, a corresponding tool is used to weld together structural steel, in particular high-strength and super. high-strength steels, as well as thick-walled pipes that, for example, can be composed of a structural steel and have a wall thickness 10 of more than 10 mm, along a weld that runs in a circumferential direction, which pipes can be used for a pipeline at a great depth. for example. Even thick-walled pipes of steel can thus be welded without changing tools using a single friction stir welding tool 1, whereby a corresponding pipeline can be produced in a particularly cost-efficient manner.

1. A friction stir welding tool, which comprises a pin and a shoulder rigidly connected to the pin, for welding components composed of a parent material formed by a steel and having a melting point of over 900° C., wherein the shoulder is at least partially composed of a first material and the pin is at least partially composed of a second material, wherein a material pairing of the first material with the parent material has a first coefficient of kinetic friction and a material pairing of the second material with the parent material has a second coefficient of kinetic friction, wherein the first coefficient of kinetic friction is lower than the second coefficient of kinetic friction.

2. The friction. stir welding tool according to claim 1, wherein the first material has a melting temperature of more than 900° C., preferably more than 2000° C.

3. The friction stir welding tool according to claim 1, wherein the second material has a melting temperature of more than 900° C., preferably more than 2000 ° C., in particular more than 3000 ° C.

4. The friction stir welding tool according to claim 1, wherein the first material and the second material have different strengths.

5. (canceled)

6. The friction stir welding tool according to claim 1, wherein the first material has a lower chemical affinity to the parent material than the second material.

7. The friction stir welding tool according to claim 1, wherein the friction stir welding tool has a shaft which comprises a third material, in particular is formed by a third material.

8. The friction stir welding tool according to claim 1. wherein the first material contains molybdenum, in particular is embodied as a molybdenum alloy.

9. The friction stir welding tool according to claim 1, wherein the second material contains tungsten, in particular is formed by tungsten-rhenium.

10. The friction stir welding tool according to claim 1, wherein the first material and/or the second material comprises a ceramic material, in particular an oxide ceramic material, and/or a non-oxide ceramic material such as carbides, nitrides, or silicides, or is formed by a material of this type.

11. The friction stir welding, tool according to claim 1, wherein the first material and/or the second material comprises a refractory metal, a refractory metal alloy, a nickel alloy, a cobalt alloy, and/or an iron alloy, or is formed by a material of this type.

12. A method for producing a friction stir welding tool having a pin and a shoulder, with which method components of a parent material formed by a steel, in particular a structural steel, which parent material has a melting temperature of more than 900° C., can be joined by friction stir welding, in particular for producing a friction stir welding tool according to claim 1, wherein a first component part, which is composed of a first material, is rigidly connected to a second component part, which is composed of a second material, so that at least a partial region of the shoulder is formed by the first material and at least a partial region of the pin is formed by the second material, wherein a material pairing of the first material with the parent material has a first coefficient of kinetic friction and a material pairing of the second material with the parent material has a second coefficient of kinetic friction, wherein the first coefficient of kinetic friction is lower than the second coefficient of kinetic friction.

13. The method according to claim 12, wherein the first component part is connected to the second component part in a materially bonded manner.

14. The method according to claim 12, wherein the first component part is welded to the second component part.

5. The method according to claim 12, wherein the first component part is connected to the second component part using a friction welding method.

16. The method according to claim 12, wherein the first component part is connected to the second component part using a pressure welding method.

17. The method according to claim 12, wherein, depending on a desired mean coefficient of kinetic friction that acts during contact of the shoulder with the parent material and lies between a first coefficient of kinetic friction, which a material pairing of the first material with the parent material has, and a second coefficient of kinetic friction, which a material pairing of the second material with the parent material has, a first partial region of the shoulder is formed by the first material and a second partial region of the shoulder is formed by the second material, in order to achieve the desired mean coefficient of kinetic friction.

18. The method according to claim 12, wherein, before a connection of the first component part to the second component part, the first component part is formed with a contour which corresponds to the partial region of the shoulder that is formed from the first material.

19. The method according to claim 12, wherein the first component part has an essentially rotationally symmetrical outer contour, in particular is embodied to be roughly ring-shaped.

20. A method for joining components of one parent material formed by a steel, in particular a structural steel, or multiple parent materials formed by a steel, in particular a structural steel, and having a melting temperature of more than 900° C. by friction stir welding, wherein a friction stir welding tool according to claim 1 is used.

21. The method according to claim 20, wherein the components are embodied to be tubular.

22. The method according to claim 20, wherein the components have a wall thickness of more than 10 mm.
